(19) United States
(12) Patent Application Publication
(10) Pub. No.: US 2012/0261269 A1
(43) Pub. Date: Oct. 18, 2012

(54) PROCESS FOR PRODUCTION OF POLYSILICON AND SILICON TETRACHLORIDE

(76) Inventors: Wataru Kagohashi, Chigasaki-shi (JP); Matsuhide Horikawa, Chigasaki-shi (JP); Kohsuke Kakiuchi, Chigasaki-shi (JP)

(21) Appl. No.: 13/518,395

(22) PCT Filed: Dec. 22, 2010
(86) PCT No.: PCT/JP2010/073132

§ 371 Date: Jun. 22, 2012

(30) Foreign Application Priority Data
Dec. 22, 2009 (JP) 2009-290797
Dec. 22, 2009 (JP) 2009-290828

(51) Int. Cl. C01B 33/023; C01B 33/08; C25C 3/02; C25C 3/06; C25C 3/34

(52) U.S. Cl. 205/369; 205/372; 205/407; 205/408; 423/343

(57) ABSTRACT

A process for production of polysilicon and silicon tetrachloride is provided in which a raw material that is supplied stably and is available at low cost can be used, chlorination reaction can be smoothly promoted, impurities generated after chlorination reaction can be controlled, and production efficiency is superior in a polysilicon producing step. The process includes a step of chlorination in which a granulated body consisting of silicon dioxide and carbon-containing material is chlorinated to generate silicon tetrachloride, a step of reduction in which silicon tetrachloride is reduced by a reducing metal to generate polysilicon, and a step of electrolysis in which chloride of the reducing metal by-produced in the reduction step is molten salt-electrolyzed to generate the reducing metal and chlorine gas. In the process, chlorine gas is supplied to the silicon dioxide and the carbon-containing material in the presence of oxygen gas, and these are reacted in the chlorination step, the reducing metal generated in the electrolysis step is reused in the reduction step as a reducing agent of silicon tetrachloride, and the chlorine gas generated in the electrolysis step is reused in the chlorination step.

### TECHNICAL FIELD

The present invention relates to a process for production of silicon tetrachloride in which silicon dioxide is used as a raw material, and relates to a process for production of polysilicon in which the silicon tetrachloride is used as a raw material. In particular in the present invention, unlike a conventional process in which silicon metal is chlorinated, silicon dioxide is directly chlorinated to silicon tetrachloride, and then the silicon tetrachloride which is obtained is reduced by a reducing metal to obtain polysilicon of high purity.

### BACKGROUND ART

Polysilicon has attracted attention from the viewpoint of solar energy utilization, particularly as a raw material for photovoltaic cells.

Conventionally, as a process for production of highly pure polysilicon for use in a silicon cell for a photovoltaic cells, the Siemens method, in which metal-graded silicon (MG-Si) is reacted with hydrogen chloride to generate silicon chloride mainly containing trichlorosilane, and trichlorosilane is reduced by hydrogen in an atmosphere containing single-crystal silicon core to deposit silicon metal onto the surface of the core crystal, a metallurgical method in which purity of silicon is improved by repeatedly melting and solidifying silicon metal, and a zinc-reducing method in which silicon tetrachloride obtained by chlorination reaction of silicon metal and silicon compounds are reduced by zinc metal to obtain silicon, have been well known. In particular, the Siemens method is now the primarily used method since highly pure silicon of not less than 9N (99.9999999%) can be produced.

However, in the Siemens method, there is still room for improvement in cost reduction since highly pure silicon metal (MG-Si) which is produced by carbon reduction of silicon dioxide in an electric furnace is used as a raw material. Furthermore, since several kinds of silicon chlorides are by-produced in trichlorosilane obtained by the method, there is also still room for improvement in reaction control and yield.

From the viewpoints mentioned above, by-products such as trichlorosilane are not generated, only silicon tetrachloride is generated, and therefore a handling process for the by-product like in the Siemens method is not necessary in the zinc reducing method or the like in which silicon dioxide is directly chlorinated to produce silicon tetrachloride.

As a method to produce silicon tetrachloride by chlorination of silicon dioxide, for example, a method in which silicon tetrachloride is efficiently produced by adding silicon carbide to silicon dioxide is known (See Japanese Unexamined Patent Application Publication No. Showa 36 (1961)-019254). However, costs of raw material are high since silicon carbide is used as a raw material of silicon dioxide in the method.

A method in which silicon tetrachloride is produced by contacting and reacting pellets consisting of silicon dioxide and carbon-containing material with chlorine gas at high temperature is disclosed (See Japanese Unexamined Patent Application Publication No. Showa 59 (1984)-050017). However, the generation rate of silicon tetrachloride disclosed in the publication is extremely low, and there are still matters to be solved until practical utilization can be realized.

Furthermore, a method in which third component boron is present with silicon dioxide and carbon-containing material to supply reaction heat and to increase reactivity of silicon dioxide so as to react with chlorine gas at high temperature, thereby improving chlorination reaction rate of silicon dioxide, is also known (See Japanese Unexamined Patent Application Publication No. Showa 57 (1982)-022101). However, since boron is extremely inhibited element in polysilicon for photovoltaic cells, there are problems to be resolved in the quality of polysilicon.

Furthermore, a method in which burned ash of biomass is used as a raw material of silicon dioxide is also known (See Japanese Unexamined Patent Application Publication No. Showa 62 (1987)-252311). Since silicon is not as thermally denatured as natural silica in the case in which biomass is used as the raw material, it is superior in the point of reactivity. However, in the method using biomass as a raw material of silicon dioxide, the raw material may not be stored stably.

Since the chlorination reaction of silicon dioxide is an endothermic reaction, a method in which silicon metal or silicon carbide is used as the heat source is also known (See U.S. Pat. No. 3,173,758). However, in the method, there is a possibility of by-producing other silicon chlorides in addition to silicon tetrachloride, and there is also still room for improvement in yield of silicon tetrachloride. Furthermore, in the process for production of polysilicon by reducing silicon tetrachloride by zinc metal, since chlorides of zinc metal is by-produced in addition to polysilicon, an efficient handling process of the chlorides is required.

Regarding this point, a method in which by-produced zinc metal chloride is molten salt-electrolyzed to recycle it in use as zinc metal and chlorine gas is known (See U.S. Pat. No. 2,773,745). As a method to transport the fused zinc metal generated by the molten salt electrolysis to the reduction process with keeping it in fused condition, a method of transporting with a transporting tank by a batch process is known. However, since a noncontinuous process is repeated in the batch process, there is still room to improve work efficiency. Furthermore, since impurities are contained in fused zinc chloride brought from the reduction process to the electrolysis process, there is still room to consider separating means for them. Furthermore, since chlorine gas produced in the electrolysis process contains chloride vapor of the electrolysis bath and water, a process to obtain highly pure chlorine gas in which the impurities are removed is required.

A recycle process in which silicon tetrachloride is generated by chlorinating silicon dioxide, polysilicon is produced by reducing this with zinc metal, and then zinc chloride by-produced in the reduction by the zinc metal is molten salt electrolyzed to recycle zinc metal, is known (See Japanese Unexamined Patent Application Publication No. 2004-210594). However, in this process, a method to solve heat shortage during chlorination reaction of silicon dioxide and a method to collect silicon tetrachloride liquid are not specifically disclosed.

Since the reaction rate of the chlorination reaction of silicon dioxide is low, there is an invention to increase reaction rate by adding boron or sulfur as a third component. Furthermore, since chlorination reaction of silicon dioxide is an endothermic reaction, there is a method considered to add silicon metal as a heat supplying material. However, in these methods, there are additional new problems, such as deterioration of purity of silicon tetrachloride generated and deterioration of yield. Regarding thermal compensation, a technique in which oxygen gas is supplied to top part of a fluidized bed formed in a chlorination furnace for production of titanium tetrachloride, not for silicon tetrachloride, to appropriately maintain temperature in the fluidized bed, is known (See Japanese Unexamined Patent Application Publication No. Showa 48 (1973)-071800).

However, since titanium tetrachloride is generated inside the fluidized bed, in the case in which oxygen gas is supplied to this part, titanium tetrachloride generated in the fluidized bed is oxidized by oxygen gas and coverts back to titanium oxide, and thereby undesirably decreases yield of titanium tetraoxide. Therefore, also in the case in which silicon dioxide is used as a raw material, it is considered that yield of silicon tetrachloride would be similarly decreased. There is still room to improve a process to supply oxygen.

### SUMMARY OF THE INVENTION

As explained so far, although individual processes for producing polysilicon using silicon dioxide as a raw material are already known, in order to organize a closed system by integrating these processes, there are several subjects to be solved such as a problem of selection of silicon raw material which can be supplied stably and at low cost, a problem to smoothly promote chlorination reaction of silicon metal, a problem of impurities in silicon after chlorination reaction or the like as mentioned above, means to effectively resolve these matters is required.

The present invention was completed in view of the above circumstances, and an object of the invention is to provide a process for production of silicon tetrachloride in which silicon dioxide that is supplied stably and is available at low cost can be used as a starting raw material, chlorination reaction of silicon dioxide can be smoothly promoted, and highly pure silicon tetrachloride can be produced efficiently and at high yield in a polysilicon producing step, and a further object of the invention is to provide a process for production of polysilicon in which silicon tetrachloride having extremely low levels of impurities produced in chlorination reaction of silicon dioxide is reduced by zinc metal and energy efficiency is superior.

As a result, the inventors have researched means to resolve the abovementioned matters under the abovementioned circumstances, they have found that highly pure polysilicon can be efficiently produced by chlorinating silicon dioxide, which is a starting raw material, directly by chlorine gas containing oxygen gas to generate silicon tetrachloride, and by reducing silicon tetrachloride with reducing metal, and the present invention was thereby completed.

That is, the process for production of polysilicon of the present invention has a step of chlorination in which granulated body consisting of silicon dioxide and carbon-containing material is chlorinated to generate silicon tetrachloride, a step of reduction in which silicon tetrachloride is reduced by a reducing metal to generate polysilicon, and a step of electrolysis in which chloride of the reducing metal by-produced in the reduction step is molten salt-electrolyzed to generate the reducing metal and chlorine gas, and in the processes, chlorine gas is supplied to the silicon dioxide and the carbon-containing material in the presence of oxygen gas, and these are reacted in the chlorination step, the reducing metal generated in the electrolysis step is reused in the reduction step as a reducing agent of silicon tetrachloride, and the chlorine gas generated in the electrolysis step is reused in the chlorination step.

In the process for production of polysilicon of the present invention, the granulated body consists of silicon dioxide having particle diameters not more than 5 μm and carbon-containing material having particle diameters not more than 10 μm, and the diameter of the granulated body is in a range from 0.1 to 2.0 mm, and the porosity of the granulated body is in a range from 30 to 65%. The carbon-containing material here means carbon black, activated carbon, graphite, coke, or charcoal.

In the process for production of polysilicon of the present invention, it is desirable that silicon tetrachloride liquid be sprayed and contacted with silicon tetrachloride gas generated in the chlorination step to cool the silicon tetrachloride gas, and at the same time, impurity chloride gas contained in the silicon tetrachloride gas be condensed in the silicon tetrachloride liquid and be separated.

In the process for production of polysilicon of the present invention, it is desirable that the silicon tetrachloride liquid be the silicon tetrachloride gas which has been contacted to the silicon tetrachloride liquid and then condensed and recovered.

In the process for production of polysilicon of the present invention, it is desirable that the silicon tetrachloride liquid generated in the chlorination step be distillated to be purified, and then be transported to the reduction step.

In the process for production of polysilicon of the present invention, it is desirable that polysilicon solid generated by reaction of the silicon tetrachloride gas and reducing metal gas, be deposited and grown on surface of another polysilicon solid in the reduction step.

In the process for production of polysilicon of the present invention, it is desirable that the chloride of the reducing metal by-produced in the reduction step be transported to the electrolysis step in a fused state.

In the process for production of polysilicon of the present invention, it is desirable that the chloride of the reducing metal to be transported to the electrolysis step in fused state be kept in an intermediate tank, and then a supernatant liquid part of the reducing metal chloride of liquid state kept in the intermediate tank be transported to the electrolysis step.

In the process for production of polysilicon of the present invention, it is desirable that the reducing metal liquid generated in the electrolysis step be transported to the reduction step as it is kept in a fused state.

In the process for production of polysilicon of the present invention, it is desirable that the chlorine gas generated in the electrolysis step be transported to tower for dehydrating and drying, and then be supplied to the chlorination step.

In the process for production of polysilicon of the present invention, it is desirable that purity of the silicon dioxide be not less than 98 wt %.

In the process for production of polysilicon of the present invention, it is desirable that purity of the carbon-containing material be not less than 90 wt %.

In the process for production of polysilicon of the present invention, it is desirable that the reducing metal be one selected from zinc, aluminum, potassium and sodium.

Furthermore, the process for production of silicon tetrachloride, which is second aspect of the invention, has a step of preliminarily adding oxygen gas to chlorine gas, a step of supplying a granulated body consisting of silicon dioxide and carbon containing material, the chlorine gas, and the oxygen gas in a chlorination furnace to react them, and a step of yielding silicon tetrachloride gas.

In the process for production of silicon tetrachloride of the second invention, the granulated body consists of silicon dioxide having particle diameters not more than 5 μm and carbon-containing material having particle diameters not more than 10 μm, and the diameter of the granulated body is in a range from 0.1 to 2.0 mm, and the porosity of the granulated body is in a range from 30 to 65%.

By the process for production of the present invention explained so far, since silicon dioxide is used as a starting raw material of the chlorination reaction, unlike in the conventional technique using silicon metal, plentiful resources can be stably used. Furthermore, since oxygen is added to chlorine gas in the chlorination step, and the reaction can be promoted without decreasing reaction rate of chlorination. Furthermore, since a conventional reaction promoting component such as boron is not added, impurity components in silicon tetrachloride generated in the chlorination step can be controlled. In this way, polysilicon having purity not less than 6N, which corresponds to photovoltaic cell grade, can be produced more efficiently and at lower cost compared to a conventional process.

### BRIEF DESCRIPTION OF DRAWINGS

FIG. 1 is a conceptual diagram showing the process for production of polysilicon of the present invention.

FIG. 2 is a flow chart diagram showing the production of silicon tetrachloride used in the production of polysilicon of the present invention.

FIG. 3 is a conceptual diagram showing the process for production of silicon by the Siemens method in a Comparative Example.

### BEST MODE FOR CARRYING OUT THE INVENTION

The best embodiments of the present invention are explained further in detail with reference to the drawings.

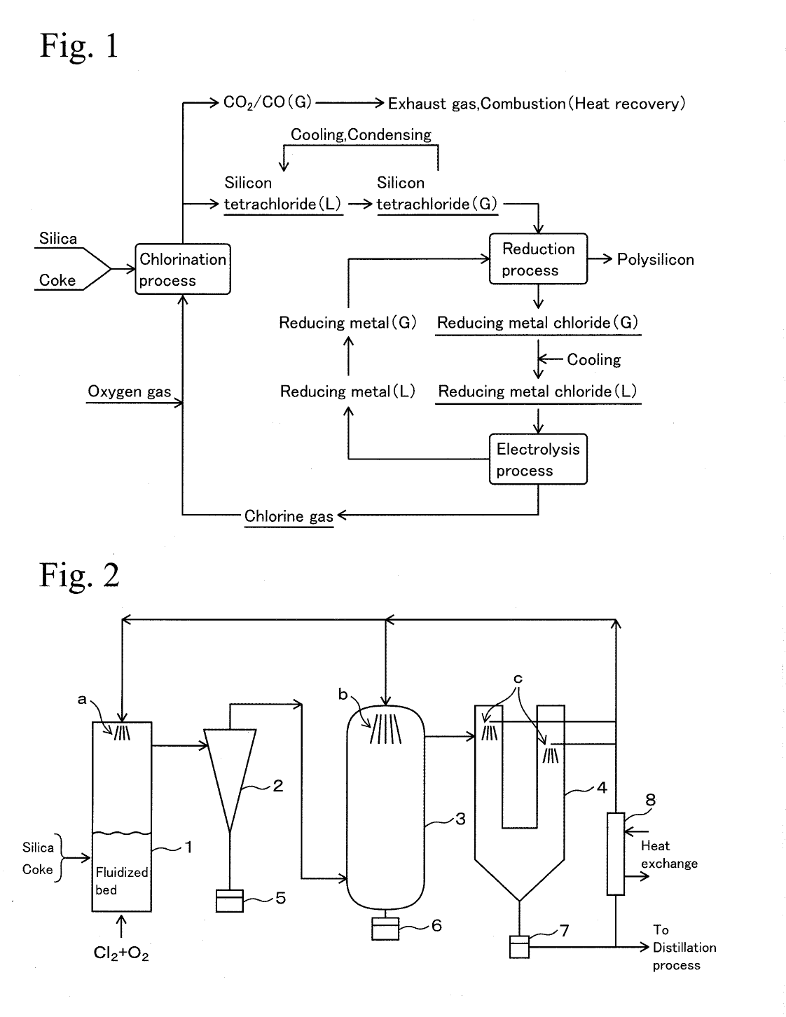

FIG. 1 shows all processes of the production of polysilicon of the present invention. In this embodiment, a case in which the reducing metal chloride is zinc chloride is explained in detail.

First, silicon dioxide (Silica in the figure) and carbon-containing material (Coke in the figure) supplied to the chlorination process are directly contacted and reacted at high temperature with chlorine gas recycled in the electrolysis process of reducing metal chloride, which is explained below, to generate silicon tetrachloride. At this time, before being supplied to the chlorination process, oxygen gas is added to chlorine gas.

Silicon tetrachloride generated in the chlorination process is transported to the reduction process and is reacted at high temperature with the reducing metal which is recycled in the electrolysis process of the reducing metal chloride explained below, to produce polysilicon. In this reaction, the reducing metal chloride is by-produced.

Polysilicon generated in the reduction process is cooled to room temperature in an inert gas atmosphere, and is supplied in a melting process so as to be enabled producing highly pure polysilicon. Furthermore, the reducing metal chloride by-produced in the reduction process is molten salt electrolyzed in the electrolysis process to recycle the reducing metal and chlorine gas.

The reducing metal recycled in the electrolysis process is transported to the reduction process, and can be reused as a reducing agent of silicon tetrachloride. Furthermore, chlorine gas by-produced in the electrolysis process can be reused as a chlorinating agent of silicon dioxide.

As explained, in the process for production of polysilicon of the present invention, silicon dioxide, carbon-containing material, and oxygen gas are supplied in the system, and CO₂/CO gas by-produced in the chlorination reaction of silicon dioxide are exhausted to the outside of the system; however, reducing metal, reducing metal chloride, and chlorine gas produced in this process are all reused in the system, and polysilicon can be efficiently produced with mediating these reused materials. Furthermore, since chlorination reaction of silicon dioxide is an endothermic reaction, reaction rate would be decreased as the reaction is promoted; however, in the present invention, since oxygen gas is preliminarily added to chlorine gas in the chlorination process, this oxygen gas reacts with part of the carbon-containing material to generate reaction heat, and thus, decreasing of the reaction rate of the chlorination reaction of silicon dioxide can be controlled.

Next, desirable aspects of the individual processes of chlorination, reduction and electrolysis included in the present invention are explained.

### 1. Chlorination Process

The process for production of silicon tetrachloride of the present invention is explained in detail with reference to FIG. 2.

In this embodiment, a case in which petroleum coke is used as the carbon-containing material is exemplified; however, coal coke and activated carbon can be used as the carbon-containing material.

### 1-a) Chlorination Reaction in the Chlorination Furnace

Chlorination reaction of silica dioxide shown as silica in the figure (hereinafter simply referred to as “silica”) and the carbon-containing material can be done in a conventional reaction furnace, such as a reaction furnace of the fixed bed type, moving bed type, or fluidized bed type. In particular, it is desirable that the chlorination reaction be performed in the fluidized bed type. By using a fluidized bed type reaction furnace, chlorination reaction of silicon dioxide can be effectively promoted.

It is desirable that chlorine gas be preliminarily heated before being supplied to the reaction part, particularly at the reaction temperature or higher. Furthermore, it is desirable that oxygen gas also be preliminarily heated. By heating preliminarily the raw material gases, temperature decrease of the reaction part according to endothermic reaction of silicon dioxide can be effectively controlled, as a result, chlorination reaction of silicon dioxide can be efficiently maintained.

The temperature of the chlorination reaction is desirably in a range from 1000 to 1500° C., and it is more desirably in a range from 1300 to 1500° C. The chlorination reaction can be smoothly promoted at such a temperature range. Chlorination reaction rate of silicon dioxide is insufficient in the case in which the temperature is less than 1000° C. On the other hand, in the case in which the temperature is greater than 1500° C., the heating furnace for chlorination must be uneconomically large since the endothermic amount is increased depending on the chlorination reaction, and it is difficult to find constitutional material of the furnace which can bear the reaction temperature. Therefore, it is desirable that the temperature of chlorination reaction be in a range from 1000 to 1500° C.

The reference numeral 1 is the chlorination furnace in FIG. 2, a mixture gas of chlorine gas and oxygen gas is supplied from the base part thereof by a conventional structure such as a dispersing base or the like (not shown), and silica and coke are supplied from the side wall thereof by a raw material hopper or the like (not shown). A fluidized bed is formed in the chlorination furnace 1 by these raw materials, and silicon tetrachloride is generated by chlorinating silica in the fluidized bed.

In the chlorination process of the present invention, silica is used as a raw material, and the silica and coke reacts with chlorine gas in the presence of oxygen gas, to produce silicon tetrachloride.

Since oxygen gas is present with the chlorine gas, part of the coke input into the chlorination furnace 1 burns with oxygen, and reaction heat is generated. By using the reaction heat, temperature decrease inside the furnace due to endothermic chlorination reaction of silica can be effectively controlled.

The amount of oxygen gas to be added to chlorine gas can be calculated as follows: endothermic amount by chlorination reaction of silica and heat discharge amount from the chlorination furnace are preliminarily calculated, and combustion heat generated by reaction of coke and oxygen is decided so as to be not less than total of the endothermic amount and heat discharge amount. By adding oxygen gas of a required amount determined as above, the temperature inside the chlorination furnace 1 can be stably maintained in a temperature range for the chlorination reaction of silica.

In the present invention, the amount of oxygen gas added to chlorine gas is desirably in a range from 5 to 100 vol %, and it is more desirably in a range from 20 to 60 vol %. In the case in which the amount of oxygen gas added to chlorine gas is more than 100 vol %, the amount of coke consumed by burning reaction with oxygen gas becomes more than the amount of coke contributing to the chlorination reaction of silica, and the reaction rate of chlorination of silica would be decreased. On the other hand, in the case in which the amount of oxygen gas added to chlorine gas is less than 5 vol %, the temperature of the reaction region is not increased enough, and the substantial reaction rate of silica would be decreased.

Oxygen gas is preliminarily added to chlorine gas before they are supplied to the chlorination reaction 1, and at this time, it is desirable that oxygen gas and chlorine gas be mixed sufficiently.

The mixture gas of chlorine gas and oxygen gas is continuously supplied from the bottom part of the chlorination furnace to the fluidized bed in which chlorination reaction of silica is promoted, and at this time, it is desirable that the gas be supplied while adjusting so that temperature of the fluidized bed is maintained in a certain temperature range in which the chlorination reaction of silica is efficiently promoted.

In this way, the chlorination reaction of silica and chlorine gas and burning reaction of coke and oxygen gas are promoted at the same time. Since oxygen gas reacts preferentially in the burning with coke, silicon tetrachloride generated in the fluidized bed is little oxidized, and therefore silicon tetrachloride can be produced at high yield.

It should be noted that in Japanese Unexamined Patent Application Publication No. Showa 48 (1973)-071800, there is a problem in that titanium tetrachloride is undesirably oxidized by supplying oxygen from a top part of the chlorination furnace in the production of titanium tetrachloride. The reason for this is that since much titanium tetrachloride exists at the top part of the chlorination furnace, it is easily oxidized. On the other hand, unlike this method, oxygen gas is introduced from the bottom part of the fluidized bed in the present invention. It is thought that little silicon tetrachloride is generated at the bottom part, oxygen reacts preferentially with coke to generate combustion heat, and the chlorination reaction of silica, coke, and chlorine gas is promoted at an upper part of the furnace where oxygen gas concentration is reduced.

In this way, by supplying a mixture gas of chlorine gas and oxygen gas from the bottom part of the chlorination furnace to the fluidized bed, the temperature in the fluidized bed can be maintained within a range appropriate for the chlorination reaction of silica, and the chlorination reaction of silica can be efficiently promoted while controlling the oxidation reaction of silicon tetrachloride.

Alternatively, oxygen gas and chlorine gas can be separately introduced into the chlorination furnace. For example, chlorine gas is introduced from a central part of the bottom part of the chlorination furnace while introducing oxygen gas from the circumference of the center. By introducing oxygen gas in this way, heat source can be formed at a circumferential part of the fluidized bed formed in the chlorination furnace, and as a result, temperature decrease caused by reaction of chlorine gas introduced from the central part of the chlorination furnace, coke, and silica, can be efficiently avoided.

In the present invention, alternatively, hydrogen gas can be further added to chlorine gas to which oxygen gas is added. By adding hydrogen gas, reaction heat of chlorine gas and hydrogen gas can be supplied to the chlorination reaction of silica. Furthermore, by reacting chlorine gas which is by-produced by oxidation reaction of oxygen gas and silicon tetrachloride generated by chlorination reaction of silica, and hydrogen gas, chlorine gas can be converted into hydrogen chloride, which is relatively easily processed.

In the present invention, silicon metal can be added to the raw material silica. Silicon metal which is added to silica generates reaction heat when reacting with chlorine gas to generate silicon tetrachloride, and the reaction heat can be effectively supplied to a reaction part in which temperature is decreased by endothermic chlorination reaction of silica.

In the present invention, by maintaining pressure inside of the chlorination furnace 1 at a higher pressure than that of the atmosphere, endothermic chlorination reaction of silica can be reduced, and as a result, the amount of oxygen gas to be added to chlorine gas can be effectively reduced.

The reason for this is that the ratio of generation of CO₂ gas is increased more than that of CO, both generated during chlorination reaction of silica, coke, and chlorine, by increasing pressure of the reaction atmosphere, and as a result, endothermic reaction accompanied by chlorination reaction can be reduced. Furthermore, by increasing pressure of the reaction atmosphere, carbon solution reaction which is a reaction of coke and CO₂ gas generated by burning reaction of coke can be efficiently controlled, and as a result, temperature decrease in the fluidized bed can be efficiently controlled at the same time.

In the present invention, pressure inside of the chlorination furnace 1 is desirably maintained in a range from 1 to 5 atm, and more desirably in a range from 1 to 3 atm. In the case in which pressure is less than 1 atm, it becomes difficult to maintain a temperature appropriate for reaction since reaction heat of chlorination of silica becomes endothermic. On the other hand, in the case in which pressure is greater than 5 atm, the cost for pressure-durable structure of the chlorination furnace 1 and other devices is uneconomic. Therefore, in the present invention, it is desirable that pressure in the chlorination furnace 1 be in a range from 1 to 5 atm.

By applying pressure in the chlorination furnace 1, amount of silica and coke splashing from the chlorination furnace 1 to a cooling system can be effectively reduced, and as a result, specific consumptions of silica and coke per unit weight of silicon tetrachloride can be effectively increased.

In the present invention, high-frequency waves or microwaves can be applied from outside to the chlorination reaction region. By absorbing the high-frequency waves or microwaves into the chlorination region, the temperature of the chlorination region can be maintained in an appropriate range to continue the reaction.

In the present invention, as a result of applying microwaves to silica and coke held in a chlorination reaction region, heat required for chlorination reaction of silica can be appropriately supplied. As a result, temperature of the reaction part can be appropriately maintained without decreasing it.

Output of the microwaves is calculated depending on heat balance of the reaction part, and the frequency can be selected from a range from 300 MHz to 30 GHz.

### 1-b) Raw Material of Silicon Tetrachloride

It is desirable that silica used in the present invention have a purity not less than 98 wt %. By using such highly-pure silica, highly-pure silicon tetrachloride can be produced. As such a silica, quartz, quartz rock, quartz sand, or diatomaceous earth (noncrystal silica) can be effectively used.

It should be noted that it is desirable that particles of silica used in the present invention be crushed and regulated to have a particle size not greater than 5 μm. Furthermore, it is more desirable that particles be crushed and regulated to have particle size not greater than 3 μm. Furthermore, noncrystal silica is desirable. By using noncrystal silica, chlorination reaction of silica can be efficiently promoted.

Also the coke used in the present invention is desirably as highly pure as possible, in particular, not less than 90 wt % is desirable. By using highly pure coke, purity of silicon tetrachloride produced in the chlorination process of silica can be maintained to be not less than 98 wt %. It is desirable that the coke be crushed and regulated to have particle size not greater than 10 μm. Furthermore, it is more desirable that particles be crushed and regulated to have particle size not greater than 5 μm. As a coke, petroleum coke, coal coke, and activated carbon can be freely selected, and in the present invention, petroleum coke or activated carbon is desirable.

In the present invention, under the conditions of coke being not more than 10 μm and silica being not more than 5 μm, ratio of particle diameter of silica to coke before granulating, a range from 0.1 to 1.0 is desirable and a range from 0.3 to 1.0 is more desirable, and a range from 0.6 to 1.0 is further desirable.

By adjusting the ratio of particle diameter of silica to coke in the above ranges, generation rate of silicon tetrachloride can be maintained at a high level. More desirably, ratio of average particle diameter of silica to coke is as close to 1 as possible. By selecting such ratio of average particle diameter of silica and coke, chlorination reaction rate of silica can be maintained at a higher level. Such conditions can be achieved by crushing silica and coke together.

Silica and coke is effectively granulated to have a target size by using a conventional granulating device and adding binder if necessary. After granulation, the granulated body consisting of silica and coke is crushed and regulated after heating and drying if necessary. Silica and coke can be granulated by using a commercially available granulating device. Binder such as water glass or TEOS (tetraethoxysilane) can be added to silica and coke. It is desirable that water glass or TEOS be added in a range from 3 wt % to 30 wt % of total weight of silica and coke. By adding binder in such a range, not only can granulated body be formed efficiently, but also subsequent binder-removing treatment can be efficiently performed. Furthermore, binding between silica and coke can be strengthened, and as a result, durable granular raw material can be prepared.

In the granulated body of the present invention, mole ratio of coke to silica is desirable in a range from 1 to 5, and more desirably in a range from 1 to 4. By adjusting the ratio of coke to silica in the granulated body in the above ranges, reaction of the granulated body and chlorine gas can be efficiently promoted.

It is desirable that the diameter of the granulated body consisting of silica and coke used in the present invention be in a range from 0.1 mm to 2.0 mm. By forming the granulated body having a size in the range, chlorination reaction can be efficiently promoted in the fluidized bed or fixed bed. In the case in which the particle diameter of the granulated body is less than 0.1 mm, undesirable splash out from the fluidized bed or fixed bed often happens, thereby results low yield. On the other hand, in the case in which diameter of the granulate body is greater than 2.0 mm, chlorination reaction rate is undesirably decreased. It is desirable to granulate to have size in a range from 0.1 mm to 1.0 mm in the case of chlorination of a granulated body consisting of silica and coke in the fluidized bed, and in a range from 1.0 mm to 2.0 mm in the case of chlorination in a fixed bed. It should be noted that particle size distribution of the granulated body can be adjusted by an operation such as classifying, sifting or the like.

In the present invention, the granulated body formed by the abovementioned method can be applied to chlorination reaction in both device structure of a fixed bed and a fluidized bed.

It is desirable that porosity of the granulated body used in the present invention be adjusted in a range from 30 to 65%. In the case in which porosity is less than 30%, generation rate of silicon tetrachloride is decreased and practical reaction rate cannot be obtained undesirably. On the other hand, in the case in which porosity is greater than 65%, shape of the granulated body in the chlorination reaction cannot be maintained and it is not practical.

It should be noted that a granulated body consisting of silica and coke granulated to have the abovementioned size is desirably heated and dried. It is desirable to heat and dry at a temperature range from 110 to 400° C. By heating in the range of temperature, water and binder contained in granulated material can be effectively evaporated and separated. Furthermore, reaction with chlorine gas can be performed stably and efficiently.

The heating and drying time is desirably in a range from 0.5 to 100 hours, and more desirably in a range from 24 to 48 hours. By setting the heating and drying time in the range, the above-mentioned binder can be effectively evaporated and separated.

In the case in which the heating and drying time is greater than 100 hours, sintering of the granulated body is promoted, thereby causing deterioration of contact efficiency with chlorine gas. On the other hand, in the case in which the drying time is less than 0.5 hours, binder contained in the granulated body is evaporated and separated insufficiently, thereby causing deterioration of yield and purity of silicon tetrachloride generated.

It is desirable that the granulated body heated and dried is then crushed and regulated. In the present invention, the granulated raw material consisting of silica and coke after crushing and regulating is desirably adjusted in a range of 0.1 to 2.0 mm by a conventional means such as classifying, sifting or the like. By adjusting in the range of particle size mentioned above, the structure of the raw material is appropriate for the fixed bed or fluidized bed.

In the present invention, not only silica and coke, but also recycled material such as silicon metal scrap can be added. By adding silicon metal, reaction heat generated by reaction with chlorine gas can be utilized to maintain temperature of chlorination reaction within an appropriate temperature range.

### 1-c) Temperature of Chlorination Reaction

In the present invention, temperature of chlorination is desirably not less than 1000° C., and in particular, more desirably not less than 1300° C. However, it is desirable that temperature of chlorination be not more than 1500° C. In the case in which temperature of chlorination is more than 1500° C., service life of the furnace wall of the chlorination furnace is shortened.

It is desirable that the inner wall of the chlorination furnace 1 be formed with carbon or silicon nitride. By using the material as the inner wall of the chlorination furnace 1, heat resistance and chlorine resistance are improved, and damaging and consuming of the inner wall of the chlorination furnace 1 by fluidized reaction of silica and coke can be efficiently controlled.

In the case in which chlorination reaction of silica is performed in the chlorination furnace 1 of the fluidized bed type, it is desirable that a granulated body consisting of silica and coke be supplied in the chlorination furnace. The granulated body loses its particle diameter accompanied by promotion of chlorination reaction, and when the diameter reaches a diameter corresponding to a speed of splashing from the fluidized bed, and the particles are splashed from the chlorination furnace 1 to the cooling system.

On the other hand, in the case in which the chlorination furnace is of fixed bed type, it is desirable that the granulated body consisting of silica and coke be supplied in the bed. By supplying the silica and coke of granulated condition to the chlorination furnace 1, chlorination reaction of silica can be efficiently performed. The size of the granulated body can be selected so that it is in an appropriate range depending on a flowing amount of chlorine gas supplied from the bottom part of the chlorination furnace 1 to the inside. From the viewpoint of reducing flowing resistance of gas, it is desirable that the granulated body having larger size be selected to be larger as the flowing amount of the chlorine gas is greater.

### 2. Solid-Liquid Separation by Cyclone

A mixture gas of silicon tetrachloride gas and other impurity gas generated in the chlorination furnace 1 is introduced to a cyclone 2 which is a solid-gas separating device. Since the mixture gas contains solid components such as silica, coke and the like which have been carried over from the chlorination furnace 1, in addition to the impurity gas, by introducing the mixture gas to the cyclone 2, these solid components can be efficiently separated. The solid component separated is collected in an impurity tank 5.

Furthermore, as shown in FIG. 2 by reference letter a, before the mixture gas is introduced to the cyclone 2, silicon tetrachloride liquid can be sprayed from the top part of the chlorination furnace 1. By spraying the silicon tetrachloride liquid, the mixture gas that is to be introduced to the cyclone 2 can be cooled to an appropriate range of temperature.

### 3. Impurity Separating by Cooling Device

The mixture of silicon tetrachloride and impurity gas of which solid components have been removed by the cyclone 2 is further introduced to a cooling device 3. As shown by reference letter b, silicon tetrachloride liquid is sprayed from the top part of the cooling device 3, so that the mixture gas introduced from the cyclone 2 is cooled to a temperature as low as possible so as not to be above the boiling point of silicon tetrachloride.

By performing gas cooling operation, one component having a higher boiling point than that of silicon tetrachloride is liquefied among the impurity gases in silicon tetrachloride gas, and it is collected in impurity tank 6 arranged at a bottom part of the cooling device 3. On the other hand, mixture gas consisting of impurity gas having lower boiling point than that of silicon tetrachloride and silicon tetrachloride gas is introduced to liquefying device 4, which is downstream.

### 4. Liquefying and Recovering in Liquefying Device

As shown by reference letter c, it is desirable that silicon tetrachloride gas and low-boiling point impurity gas introduced to the liquefying device 4 be contacted with silicon tetrachloride liquid sprayed from the top part.

By contacting silicon tetrachloride gas including low boiling point impurity gas with silicon tetrachloride liquid, the silicon tetrachloride gas is cooled and is recovered in tank 7 as silicon tetrachloride liquid.

Most of the gas which is not condensed and recovered by the liquefying device 4 is CO gas, and this CO can be burnt so that its combustion heat is used as a heat source for distillation and purification device of silicon tetrachloride which is subsequent process.

As the silicon tetrachloride liquid c for gas cooling used in the liquefying device 4, one which is part of silicon tetrachloride recovered in the liquefying device 4 and cooled at heat exchanging device 8 can be used. Furthermore, silicon tetrachloride liquid a and b used in the chlorination furnace 1 and the cooling device 3 are prepared similarly. In the present invention, it is desirable that the silicon tetrachloride liquid be kept in a temperature range from 10 to 30° C.

### 5. Recovering to the Tank

It is desirable that after solid impurities are removed by thickener or liquid cyclone from silicon tetrachloride liquid recovered in the liquefying device 4 that its supernatant be introduced to distillation and purification process, not shown, via tank 7. By treating silicon tetrachloride liquid by the thickener or liquid cyclone, silica and coke contained in liquid silicon tetrachloride can be efficiently removed.

Furthermore in the present invention, by introducing silicon tetrachloride which is treated by the thickener or liquid cyclone to the tank 7, silica and coke contained in silicon tetrachloride liquid can be separated by specific gravity, and further pure silicon tetrachloride can be introduced to the distillation and purification process.

In the present invention, it is desirable that silicon tetrachloride gas generated in the chlorination process be once cooled to form liquid silicon tetrachloride, this is distillated and purified to be highly pure silicon tetrachloride, and this is supplied to the subsequent reduction process.

It is desirable that silicon tetrachloride gas generated in the chlorination process be collected as silicon tetrachloride liquid by contacting with silicon tetrachloride liquid which is formed by cooling silicon tetrachloride gas.

CO₂ and CO gases are also by-produced in addition to silicon tetrachloride in the chlorination process, and it is desirable that heat generated by burning the CO gas be collected. By heating water with the collected heat to obtain water vapor, the vapor can be used as a heat source for distillation and purification process of silicon tetrachloride.

### 6. Reduction Process

In the reduction process of the present invention, in order to improve purity of polysilicon obtained, it is desirable that reduction reaction of both silicon tetrachloride generated in the chlorination process and reducing metal (for example, zinc metal) by-produced in the electrolysis process be performed in gas-phase. Polysilicon generated by the gas phase reduction reaction is deposited as silicon solid, and reducing metal chloride (for example, zinc chloride) by-produced in the reduction reaction is recovered in a gas state and is condensed and separated in a subsequent process. By employing such reaction conditions, contamination of the reducing metal chloride (for example, zinc chloride) into polysilicon generated can be effectively controlled. In the case in which zinc metal is exemplified as reducing metal, since the melting point of zinc chloride is 420° C., the boiling point of zinc chloride is 756° C., and the melting point of polysilicon is 1414° C., polysilicon can be generated in a solid state in the reduction reaction and zinc chloride can be by-produced in a gas state, by keeping temperature of the reaction part at a temperature not less than the boiling point of zinc chloride and not more than the melting point of polysilicon.

Furthermore, in the present invention, polysilicon generated in the reaction of the silicon tetrachloride gas and the zinc chloride gas can be deposited and grown on a solid surface of polysilicon which is preliminarily arranged at the reaction part. By arranging the solid surface purposely, silicon metal generated in the reaction of silicon tetrachloride and zinc metal gas can be efficiently deposited and grown.

The solid surface of polysilicon can be constructed by including tabular or cylindrical polysilicon. Furthermore, by forming an exhaust nozzle of the silicon tetrachloride gas with polysilicon, a top part of the nozzle can be utilized as a depositing site of polysilicon as the solid surface. Polysilicon crystal itself formed on top of the nozzle functions as new solid surface, and polysilicon can be deposited and grown efficiently.

As the reducing metal, metals such as aluminum or the like can be used in addition to the above-mentioned zinc metal; in the present invention, the zinc metal is desirable for a reducing agent of silicon tetrachloride. By using the zinc metal as the reducing agent, polysilicon generated can be maintained at a high level of purity.

The polysilicon is heated and melted, to obtain a silicon ingot that is highly pure single crystal or a multicrystal.

### 7. Electrolysis Process

In the electrolysis process of the present invention, before putting the reducing metal chloride in a fused state transported from an upstream reduction process into a electrolysis vessel of the reduction process, it is desirable that supernatant part of the reducing metal chloride kept in a storage tank be supplied to the electrolysis vessel after the reducing metal chloride is once transported to the storage tank and held for a predetermined number of hours. By placing the reducing metal chloride by-produced in the reduction process, reducing metal contained in the reducing metal chloride can be effectively separated and removed.

An example in which zinc metal and zinc chloride are used as the reducing metal and the reducing metal chloride, is explained as follows. Since specific weight of zinc metal is greater than that of zinc chloride, by placing and separating zinc chloride by-produced in the reduction process, zinc metal contained in zinc chloride can be precipitated and separated in the zinc chloride layer. As a result, by drawing and discharging the supernatant part, highly pure zinc chloride can be supplied into the electrolysis vessel.

Zinc chloride supplied into the electrolysis vessel can be recycled as zinc metal and chlorine gas by being molten-salt electrolyzed in the electrolysis vessel. The recycled chlorine gas and zinc metal can be effectively used as a chlorination agent of silica and a reducing agent of silicon tetrachloride generated in chlorination reaction of silica, respectively.

In the present invention, before transporting chlorine gas to the chlorination process, it is desirable that the water component be removed from the chlorine gas generated in the molten salt electrolysis process, in a dehydration drying tower. For example, by passing chlorine gas generated in the molten salt electrolysis process through a sulfuric acid drying tower, a water component and a mist component contained in chlorine gas can be efficiently removed.

As the fused salt used in the electrolysis process, for example, it is desirable to use by adding a third component such as calcium chloride, sodium chloride or the like By using such an electrolysis bath, temperature of the molten salt electrolysis can be decreased, and as a result, electric current efficiency can be effectively increased.

It is desirable that the reducing metal (for example, zinc metal) generated in the molten salt electrolysis of the reducing metal chloride (for example, zinc chloride) be transported to the reduction process held in a fused state. In addition, it is desirable that the reducing metal (for example, zinc metal) transported to the reduction process be vaporized to be a reducing metal gas (for example, zinc metal) by heating from the outside.

As explained so far, in the present invention, by using silica as a starting raw material, silicon tetrachloride is generated efficiently by chlorination reaction of silica by chlorine gas to which oxygen gas has been added preliminarily, and reducing this by the reducing metal (for example, zinc metal), highly pure polysilicon can be efficiently produced.

In addition, reducing metal chloride (for example, zinc chloride) by-produced in the reduction reaction can be recycled as a reducing metal (for example, zinc metal) and chlorine gas by fused salt electrolysis, and as a result, the reducing metal (for example, zinc metal) and chlorine gas can be recycled as a reducing agent of silicon tetrachloride and chlorinating agent of silica, respectively, and this is desirable from the viewpoint of protection of resources.

### EXAMPLES

The present invention is further practically explained by way of the following Examples.

### Example 1

Using the device shown in FIG. 2 under the following conditions, silicon tetrachloride was generated in a chlorination process using silica as a raw material, and silicon tetrachloride was reduced by zinc metal vapor in a reduction process to obtain polysilicon solid. Furthermore, zinc chloride by-produced in the reduction process was molten salt electrolyzed to zinc metal and chlorine gas in the electrolysis process, and they were reused as reducing agent of silicon tetrachloride and chlorinating agent of silica, respectively. Furthermore, polysilicon generated in the reduction process was melted and deposited on crystal core as a highly pure silicon.

### 1. Chlorination Process

### 1) Raw Material

Granulated body having size in a range from 1 to 2 mm was formed by using the following raw materials to employ chlorination reaction.

(1) Silica: Purity 98 wt %, particle diameter after crushing 5 μm

(2) Coke: Purity 90 wt %, particle diameter after crushing 10 μm, petroleum coke

(3) Binder: Water glass (additional ratio to silica and coke: 5 wt %)

Particle diameter of silica and coke used in the chlorination reaction were measured by a laser light scattering diffractometry particle size measuring device. The particle diameter (particle diameter of 50% integrated particle diameter in volume integrated particle size distribution) was measured as follows: using particle size distribution measuring device LA-920 (produced by HORIBA, Ltd.), a sample was put in 0.2% water solution of sodium hexametaphosphate, dispersed by an ultrasonic dispersing device arranged in LA-920 (output 30 W—range 5) for 3 minutes, and measured. Particle diameter of granulated body was adjusted so as to be 1 to 2 mm by sifting.

2) Temperature of chlorination: 1300 to 1500° C.
3) Chlorination furnace: Reactor having carbon lining inner wall
4) Flow amount of chlorine gas: 2.4 liter/min
5) Oxygen gas: Oxygen gas was added to chlorine gas in 30 vol % of chlorine
6) Reaction type: Fixed bed
7) Filled ratio of coke/silica in the fixed bed: 2
8) Filled weight of silica in the fixed bed: 90 g

Chlorine gas to which oxygen gas had been added was supplied in the furnace under the above conditions. It was confirmed that the inner temperature of the furnace was increased to 1200° C., and silicon tetrachloride was continuously generated. Reaction rate index of silica was calculated by the following formula (1) depending on weight of silicon tetrachloride recovered and weight of silica put into the furnace. The value was 6 (g−SiCl₄/min).

Reaction rate=(Weight of recovered silicon tetrachloride)/Reaction time (g−SiCl₄/min) (1)

### 2. Reduction Process

### 1) Raw Material

Silicon tetrachloride: Silicon tetrachloride generated in the chlorination process
Zinc metal: zinc metal recycled by molten salt electrolysis of zinc chloride by-produced in the reduction process

### 2) Reduction Temperature: 900 to 1100° C.

3) Polysilicon: Polysilicon generated in the reaction part was cooled in inert gas and recovered as a product.

### 3. Electrolysis Process

1) Raw material of electrolysis: Zinc chloride by-produced in the reduction process
2) Electrolysis vessel: Bipolar type molten salt electrolysis vessel
3) Electrolysis bath component: Zink chloride: Sodium chloride=60:40 (mol %)
4) Electrolysis product: Fused zinc metal (used as reducing agent of silicon tetrachloride back in the reduction process)

### Example 2

After mixing silica and coke of Example 1 before crushing at a mole ratio of 1:2 and placing in a ball mill, particle diameter of silica and coke was changed by changing the crushing time using crushing machine. After adding TEOS at 25% amount of silica and coke, they were treated to form a granulated body by using a granulating machine. After heating and drying, the granulated body was regulated in a range from 0.5 mm to 1 mm. Chlorination test was performed by using a fixed bed, and generation of silicon tetrachloride could be confirmed.

Reaction rate index of silica was calculated by the formula (1). Reaction rates confirmed under several test conditions are shown in Table 1.

By employing a granulated body consisting of silica having a particle diameter not greater than 5 μm and coke having particle diameter not greater than 10 μm in the chlorination reaction, generation of silicon tetrachloride was efficiently confirmed. In particular, reaction rate of silicon tetrachloride in the case of using silica having particle diameter of 3 μm and coke having particle diameter of 5 μm was confirmed to be more than three times than that in the case of using silica having particle diameter of 10 μm and coke having particle diameter of 45 μM. Furthermore, it was confirmed that it was more than twice than that even in the case of using silica having particle diameter of 5 μm and coke having particle diameter of 10 μm.

TABLE 1
Unit: (g-SiCl₄/min)

| | | Particle diameter | | |
|---|---|---|---|---|
| | | of silica (μm) | | |
| | | 3 | 5 | 10 |
| Particle | 5 | 9 | 6 | 4 |
| diameter of | 10 | 8 | 6 | 3 |
| coke (μm) | 45 | 3 | <3 | <3 |
| | 50 | <3 | <3 | <3 |

### Example 3

Mole ratio of silica and coke consisting the granulated body in Example 2 was varied to several values, and its effect on generation of silicon tetrachloride was tested. The results are shown in Table 2. In the case in which mole ratio of coke to silica was in a range from 1.0 to 4.0, utilization ratio of chlorine gas was not less than 90%, which was good reactivity. However, in the case in which mole ratio of coke to silica was 0.5, utilization ratio of chlorine gas was decreased to 50%.

Here, the utilization ratio of chlorine gas was defined as a mole ratio (%) of chlorine gas amount calculated from recovered silicon tetrachloride versus supplied amount of chlorine gas. By this Example, it was confirmed that the mole ratio of coke to silica in the granular body was desirably in a range from 1.0 to 4.0.

TABLE 2

| | Utilization ratio of |
|---|---|
| C/SiO₂ | chlorine gas (%) |
| 4.0 | 99 |
| 2.0 | 100 |
| 1.0 | 90 |
| 0.5 | 50 |

### Example 4

In Example 2, particle diameter of silica and coke were set at 5 μm, porosity was set at 50%, and only the particle diameter of the granulated body was changed. Carry over loss and reaction rate were measured, and the results are shown in Table 3.

In the case in which particle diameter of the granulated body was less than 0.1 mm, carry over loss tended to be radically increased. On the other hand, in the case in which particle diameter of the granulated body was over 2.0 mm, reaction rate tended to be decreased. Therefore, in the present invention, it was confirmed that the desirable range of particle diameter of granulated body is from 0.1 to 2.0 mm.

The carry over loss is shown as weight of solid component recovered in the cooling system, and the reaction rate is shown as a calculated value by the above mentioned formula (1) in Table 3.

TABLE 3

| | Particle diameter of | | | | |
|---|---|---|---|---|---|
| | granulated body (mm) | | | | |
| | 0.05-0.1 | 0.1-0.5 | 0.5-1.0 | 1.0-2.0 | 2.0-2.5 |
| Carry over loss (g) | 25 | 21 | 20 | 18 | 17 |
| Reaction rate | 8.6 | 7.2 | 6.8 | 6.1 | 5.7 |
| (g-SiCl₄/min) | | | | | |

### Example 5

In Example 2, particle diameter of silica and coke were set at 5 μm, and particle diameter of granulated body was changed in a range from 0.5 mm to 1 mm. Effect of porosity against reaction rate and strength of granulated body was measured by chlorination test, and the results were shown in Table 4.

Porosity of the granulated body was adjusted by varying driving time of granulating machine and added amount of TEOS as a binder. In addition, porosity was calculated on the assumption that the granulated body was spherical and was filled by hexagonal closest packing. Reaction rate was calculated by the above-mentioned formula (1).

In the range of porosity from 30% to 65%, while maintaining the shape of the granulated body, the chlorination reaction could be promoted until the end. However, in the case in which the porosity was less than 30%, the reaction rate was only half of the case in which porosity was 50%. On the other hand, in the case in which porosity was 70% which is greater than the case of 65%, the granulated body was pulverized and splashed to the outside in the midway of chlorination reaction in the fixed bed.

The mark “∘” in the broken property in Table 4 means that shape of the granulated body was maintained until the end of the chlorination reaction. On the other hand, the mark “Δ” means that the granulated body was pulverized and was not able to maintain its shape and splashed to the outside midway in the chlorination reaction.

TABLE 4

| | Porosity (%) | | | | | | |
|---|---|---|---|---|---|---|---|
| | 10 | 25 | 30 | 50 | 55 | 65 | 70 |
| Reaction rate | 3.4 | 4.1 | 6.1 | 6.5 | 7.5 | 7.8 | 2.7 |
| (g-SiCl₄/min) | | | | | | | |
| Broken property | ∘ | ∘ | ∘ | ∘ | ∘ | ∘ | Δ |

### Comparative Example 1

The inventors tried to produce silicon tetrachloride in a condition similar to that of Example 1 except for not adding oxygen gas; however, temperature was decreased midway in the reaction, and the reaction had to be stopped.

### Comparative Example 2

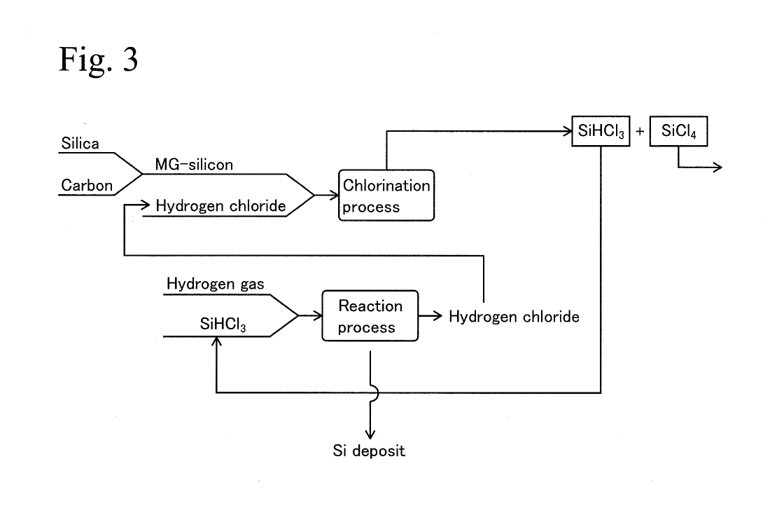

Polysilicon was deposited and generated by hydrogen reduction of trichlorosilane obtained in reaction of MG-Si silicon and hydrogen chloride, via the Siemens method, as shown in FIG. 3.

It was confirmed that specific energy consumption during production of polysilicon by the method of the present invention (Example) was from 10 to 30% reduced than that of a conventional method (Comparative Example 2). In addition, consumed amount of coke was also reduced compared to that in the conventional Siemens method. Furthermore, hydrogen gas was also unnecessary in the present invention, and production cost was also less than in the conventional method.

The present invention is appropriate for production of highly pure polysilicon of photovoltaic cell grade using less energy and at lower cost than in conventional methods.

1. A process for production of polysilicon via silicon tetrachloride using silicon dioxide as a raw material, comprising:
a step of chlorination in which a granulated body consisting of silicon dioxide and carbon-containing material is chlorinated to generate silicon tetrachloride,
a step of reduction in which silicon tetrachloride is reduced by a reducing metal to generate polysilicon, and
a step of electrolysis in which chloride of the reducing metal by-produced in the reduction step is molten salt-electrolyzed to generate the reducing metal and chlorine gas,
wherein chlorine gas is supplied to the silicon dioxide and the carbon-containing material in the presence of oxygen gas and these are reacted in the chlorination step,
the reducing metal generated in the electrolysis step is reused in the reduction step as a reducing agent of silicon tetrachloride, and
the chlorine gas generated in the electrolysis step is reused in the chlorination step.

2. The process for production of polysilicon according to claim 1, wherein the granulated body consists of silicon dioxide having a particle diameter not greater than 5 μm and a carbon-containing material having a particle diameter not greater than 10 μm, diameter of the granulated body is in a range of 0.1 to 2.0 mm, and porosity of the granulated body is in a range of 30 to 65%.

3. The process for production of polysilicon according to claim 1, wherein silicon tetrachloride liquid is sprayed and contacted with silicon tetrachloride gas generated in the chlorination step to cool the silicon tetrachloride gas, and at the same time, impurity chlorides gas contained in the silicon tetrachloride gas is condensed in the silicon tetrachloride liquid and is separated.

4. The process for production of polysilicon according to claim 3, wherein the silicon tetrachloride liquid is formed by contacting the silicon tetrachloride gas with the silicon tetrachloride liquid, and then condensed and recovered.

5. The process for production of polysilicon according to claim 1, wherein the silicon tetrachloride gas generated in the chlorination step is distillated to be purified, and then transported to the reduction step.

6. The process for production of polysilicon according to claim 1, wherein polysilicon solid generated by reacting the silicon tetrachloride gas and a reducing metal gas, is deposited and grown on a surface of another polysilicon solid in the reduction step.

7. The process for production of polysilicon according to claim 1, wherein the chloride of the reducing metal by-produced in the reduction step is transported to the electrolysis step in a fused state.

8. The process for production of polysilicon according to claim 7, wherein the chloride of the reducing metal to be transported to the electrolysis step in a fused state is held in an intermediate tank, and then supernatant liquid part of the reducing metal chloride of liquid state held in the intermediate tank is transported to the electrolysis step.

9. The process for production of polysilicon according to claim 1, wherein the reducing metal liquid generated in the electrolysis step is transported to the reduction step as it is held in fused state.

10. The process for production of polysilicon according to claim 1, wherein the chlorine gas generated in the electrolysis step is transported to a tower for dehydrating and drying, and then is supplied to the chlorination step.

11. The process for production of polysilicon according to claim 1, wherein purity of the silicon dioxide is not less than 98 wt %.

12. The process for production of polysilicon according to claim 1, wherein purity of the carbon-containing material is not less than 90 wt %.

13. The process for production of polysilicon according to claim 1, wherein the reducing metal is one selected from zinc, aluminum, potassium and sodium.

14. The process for production of polysilicon, wherein the polysilicon produced by the process according to claim 1 is highly pure polysilicon having a purity not less than 6N.

15. A process for production of silicon tetrachloride, comprising:
a step of preliminarily adding oxygen gas to chlorine gas,
a step of supplying a granulated body consisting of silicon dioxide and carbon containing material, the chlorine gas, and the oxygen gas in a chlorination furnace to react them, and
a step of yielding silicon tetrachloride gas.

16. The process for production of silicon tetrachloride according to claim 15, wherein the granulated body consists of silicon dioxide having a particle diameter not greater than 5 μm and carbon-containing material having particle diameter not greater than 10 μm, diameter of the granulated body is in a range of 0.1 to 2.0 mm, and porosity of the granulated body is in a range of 30 to 65%.
